(19) United States
(12) Patent Application Publication
(10) Pub. No.: US 2024/0391055 A1
(43) Pub. Date: Nov. 28, 2024

(54) GENERATION OF GEM CUTS

(71) Applicant: Gemological Institute of America, Inc. (GIA), Carlsbad, CA (US)

(72) Inventors: James CONANT, Escondido, CA (US); Jason QUICK, Las Vegas, NV (US); Ilene Miller REINITZ, Chicago, IL (US); Brock Aaron WILKE, Henderson, NV (US); Alexander Abraham BALTER, Livingston, NJ (US); Troy BLODGETT, Dartmouth, MA (US); Abhijith PRABHU, Las Vegas, NV (US); Al GILBERTSON, Carlsbad, CA (US); Jacob RESSLER-CRAIG, Las Vegas, NV (US)

(21) Appl. No.: 18/671,655

(22) Filed: May 22, 2024

Related U.S. Application Data
(60) Provisional application No. 63/468,242, filed on May 22, 2023.
(60) Provisional application No. 63/468,226, filed on May 22, 2023.

(51) Int. Cl. B24B 51/00; B24B 9/16; B28D 5/00

(52) U.S. Cl. CPC B24B 51/00; B24B 9/16; B28D 5/00

(57) ABSTRACT

The present embodiments relate to systems and methods for generating all possible gemstone faceting arrangements. An apparatus can include a computer, a computerized file storage system for saving results, and a mechanism that generates faceting arrangements satisfying user-defined constraints. The apparatus can feature a program that enables loading gemstone faceting designs and can offer adjustable settings to control the specific geometric parameters. The program can also provide users with 3D models satisfying geometric constraints. Additionally, the apparatus may incorporate a ray-tracing engine to assess the light performance qualities of the virtual gemstone model. The present embodiments can also include methods for optimizing diamond cut using a genetic algorithm.

### CROSS-REFERENCE TO RELATED APPLICATIONS

This application claims priority to U.S. Provisional Patent Application No. 63/468,242, titled “DIAMOND CUT ANALYSIS,” and filed May 22, 2023, and U.S. Provisional Patent Application No. 63/468,226, titled “GENERATION OF GEM CUTS,” and filed May 22, 2023, the entirety of which are incorporated by reference herein.

### FIELD

The field includes determining faceting arrangements of gemstones and gemstone cutting.

### BACKGROUND

A gemstone cut refers to the faceting arrangement on a gem. The process of designing a new cut is useful both from the perspective of consumer interest in novel and bespoke designs, but also from the perspective of having more models available for planning software to fit within a diamond rough or larger gem. Choosing proportions for a design that leads to good light performance and patterning is a fundamental problem in the field. Creating new gemstone designs has in the past involved using software like GemCad to mimic the cutting process of an actual rough to produce a model with specific proportions, a process that can be quite tricky and time consuming.

A fundamental problem facing a diamond manufacturer is how to cut a rough, or blocked stone, or existing cut into a polished diamond or diamonds. A system by which a manufacturer can scan the diamond material to produce a 3D model, fit models with varied faceting arrangements and proportion sets in order to maximize yield and cut scores is of evident importance to the field. The ability to generate a wide variety of faceting arrangements of 3D models and to vary the proportions as flexibly as possible, is useful for planning and the creation of novel diamond designs.

### SUMMARY

Systems and methods as described herein can be used for listing all possible gem cuts in increasing order of complexity in which the gems are assumed to have a crown and pavilion. The methodology can use the mathematics of the Maxwell-Cremona correspondence to equip each faceting arrangement with a set of knobs that allows the user to explore the entire space of proportion sets. Further, geometric constraints such as facet angle and azimuth or table size can be specified, and a program can find a corresponding 3D model.

The present embodiments, additionally or alternatively, can be used to find novel gem cuts that satisfy certain technical and aesthetic considerations. Such embodiments can in particular be useful for bespoke diamond creation as well as planning. Further, the user can have a larger variety of stone shapes to choose from when planning out the cutting of gem material. The present embodiments can also include a method to efficiently explore parameter space using machine learning (ML) and artificial intelligence (AI) methods.

In an example embodiment, additionally or alternatively, a method for creating a virtual gemstone model with a faceting arrangement is provided. The method can include obtaining, at a computer, a set of measurements relating to a gemstone. The method can also include detecting, at the computer, a selection of a crown and/or a pavilion of the set of measurements relating to the gemstone and one or more filters for a desired gemstone parameter. The method can also include generating, by the computer, a 3D model of the gemstone based on the selected crown and/or pavilion and the one or more filters, wherein the 3D model is configured to be used in planning or cutting a gemstone material.

In some instances, additionally or alternatively, the method can include generating the 3D model which comprises combining the crown and pavilion and converting the crown and pavilion into the 3D model via a Maxwell-Cremona correspondence between the crown and pavilion.

In some instances, additionally or alternatively, the method can include obtaining a selection of one or more parameters of a set of tunable parameters to modify the 3D model and generate any possible gemstone geometry with a given facet arrangement of the gem material.

In some instances, additionally or alternatively, the method can include transmitting the 3D model to a planning tool configured to generate planning instructions for cutting and/or polishing the gem material.

In some instances, additionally or alternatively, the method can include obtaining, by the computer, a selection to optimize the 3D model with at least one metric selected and generating, by the computer, a maximized virtual 3D model that maximizes the selected metric.

In some instances, additionally or alternatively, the method can include creating, by the computer, an n dimensional grid of diamond geometries formed by varying chosen parameters, filtering a set of models into a subset of virtual models based on the grid of diamond geometries formed by varying the chosen parameters, and selecting the subset of models as a library of models to be passed to the planning tool.

In some instances, additionally or alternatively, multiple libraries of models are passed to the planning tool to allow multiple options in cutting and polishing the gem material.

In another example embodiment, additionally or alternatively, a system is provided. The system can include a processor and a memory comprising instructions that, when executed by the processor, cause the processor to perform steps. The steps can include obtaining a set of measurements relating to a gemstone. The steps can also include detecting a selection of a crown and a pavilion of the set of measurements relating to the gemstone and one or more filters for a desired gemstone parameter. The steps can also include generating a 3D model of the gemstone based on the selected crown and/or pavilion and the one or more filters.

In some instances, additionally or alternatively, generating the 3D model comprises combining the crown and pavilion and converting the crown and pavilion into the 3D model via a Maxwell-Cremona correspondence between the crown and pavilion.

In some instances, additionally or alternatively, the steps further comprise obtaining a selection of one or more parameters of a set of tunable parameters to modify the 3D model and generate any possible gemstone geometry with a given facet arrangement of the gem material.

In some instances, additionally or alternatively, the steps further comprise transmitting the 3D model to a planning tool configured to generate planning instructions for cutting and/or polishing the gem material.

In some instances, additionally or alternatively, the steps further comprise obtaining a selection to optimize the 3D model with at least one metric selected and generating a maximized virtual 3D model that maximizes the selected metric.

In some instances, additionally or alternatively, the steps further comprise creating an n dimensional grid of diamond geometries formed by varying chosen parameters, filtering a set of models into a subset of virtual models based on the grid of diamond geometries formed by varying the chosen parameters, and selecting the subset of models as a library of models to be passed to the planning tool.

In some instances, additionally or alternatively, multiple libraries of models are passed to the planning tool to allow multiple options in cutting and polishing the gem material.

In another example embodiment, additionally or alternatively, a method for generating an optimized list of 3D models for a specified facet arrangement or facet arrangement type of a gemstone is provided. The method can include receiving, at a computer, a selection defining one or more target parameters which the list of 3D models fit inside. The method can also include receiving, at the computer, a list of facet arrangements. The method can also include receiving, at the computer, a list of performance and geometry criteria related to light performance, virtual facet patterning, outline, and/or weight, in the list of facet arrangements. The method can also include causing storage, by the computer, of the facet arrangements, virtual facet patterning, outline, and/or weight. The method can also include generating a set of 3D models with different parameter sets, wherein the set of 3D models fit inside the target parameters and meets or exceeds the list of performance and geometry criteria.

In some instances, additionally or alternatively, the target parameters are part of a wireframe of a rough gemstone or portion of rough gemstone from which a gem is configured to be polished.

In some instances, additionally or alternatively, the target parameters comprise a wireframe of a polished gem from which a more optimized gem is capable of being re-cut.

In some instances, additionally or alternatively, the generation of the set of 3D models are generated via a genetic algorithm using defining parameters including spring tensions as genetic material in order to maximize a volume yield of the gemstone.

In some instances, additionally or alternatively, the method can include generating the set of 3D models includes combining a selected crown and pavilion and converting the crown and pavilion into the set of 3D models via a Maxwell-Cremona correspondence between the crown and pavilion.

In some instances, additionally or alternatively, the method can include transmitting the set of 3D models to a planning tool configured to generate planning instructions for cutting and/or polishing the gem material.

In another example embodiment, additionally or alternatively, a computer-implemented method for creating a diamond design encyclopedia is provided. The method can include automatically generating a list of faceting arrangements up to a certain complexity, using the enumeration algorithm. The method can also include auto-populating with best guess proportion sets and displaying the charts and interactive content. The method can also include creating an interface for the user to adjust proportion sets and display newly calculated charts. The method can also include, in some examples, allowing the user to click to optimize or request a consultation with a diamond design team.

In some instances, additionally or alternatively, the method can accept a 3D scanned model from a contact measuring device, and determine its symmetry type and generating graph for the purposes of gemstone faceting classification.

In some instances, additionally or alternatively, the method can accept a 3D model of a diamond, and use the method of gradient descent on the spring tensions, determining a diagram with girdle thickness as uniform as possible.

In some instances, additionally or alternatively, the method can accept a 2D design to determine its symmetry type and generating graph, to assess whether it can be lifted to a valid 3D model, and then to create an adjustable 3D model with tunable parameters.

In another example embodiment, additionally or alternatively, a method for generating all symmetric gemstone faceting arrangements up to a specified complexity is provided. The method can include receiving, at a computer with a processor and memory, a selection defining a symmetry type and a number of vertices for a crown and a pavilion. The method can also include causing storage, by the computer, of a fundamental domain for each gem cut, positioning vertices as required and connecting each of the vertices with edges to create an abstract graph T. The method can also include enumerating all subgraphs of this graph, by the computer, removing duplicates, and verifying connectivity of each subgraph. The method can also include, by the computer, after expanding the graph to have a 3-fold symmetry, confirming planarity and triconnectivity of the graph using a Tutte embedding and a facet tracing algorithm. The method can also include, by the computer, returning a list of all such graphs that satisfy one or more constraints and writing the list of all such graphs to a computer file.

In some instances, additionally or alternatively, the method can include obtaining a selection of a faceting arrangement from a tabulated list.

In another example embodiment, additionally or alternatively, a method for enabling a user to generate all possible geometric proportion sets for a faceting arrangement. The method can include importing a faceting arrangement from a file or user input. The method can also include allowing a user to modify the outer contour using Bezier curves or a similar modeling method. The method can also include permitting the user to assign a positive weight (spring tension) to each edge. The method can also include creating a 3D model from this information, using the Maxwell-Cremona correspondence. The method can also include saving the 3D model to a file.

In some instances, additionally or alternatively, the program generates and saves sets of 3D models based on user-defined ranges and step sizes.

In another example embodiment, additionally or alternatively, a method to allow a user to generate all possible geometric proportion sets for a faceting arrangement is provided. The method can include importing the faceting arrangement from a file or user input. The method can also include allowing the user to adjust the geometric model by using a program that converts desired geometric properties such as facet angle and azimuth, table size, and facet ratios into linear equations in the spring tensions. The method can also include solving the linear equations to produce a geometric model. The method can also include saving the 3D model to a file.

In some instances, additionally or alternatively, the program generates and saves sets of 3D models based on user defined ranges and step sizes.

In some instances, additionally or alternatively, the method can include searching a proportion sets of a particular diamond cut, or multiple cuts at once, via a genetic algorithm using defining parameters such as spring tensions as genetic material, in order to maximize a chosen metric.

In some instances, additionally or alternatively, the method can include using a neural network to do a regression model of the metric to improve computation times.

In some instances, the additionally or alternatively, method can include detecting a selection to find proportions that optimize a chosen metric for a given faceting arrangement.

In another example embodiment, a method for predicting diamond metric values based on a parameter input is provided. The method can include obtaining a set of parameters for a set of measurements for a gem material. A trained neural network model can be implemented as a regression model to predict diamond metric values for a specific cut, or for all cuts with a specific symmetry type and number of vertices. The method can also include applying a genetic algorithm to maximize any metric for a single cut or for all cuts in a given symmetry class. In some instances, a ML model implementing a COBLYA algorithm can be used for optimization. An algorithm can be a computational optimization technique inspired by the process of natural selection and evolution. The algorithm can use a population of candidate solutions, evolving them over multiple generations by applying operations analogous to genetic crossover, mutation, and selection.

In some examples, the genetic material can include the set of parameters describing a diamond proportion set, such as a length/width ratio, and crown angle, or spring tension parameters augmented with girdle profile information.

In some instances, a genetic mutation process can be implemented by a random variation of a subset of parameters. The genetic mutation process can include choosing a subset of the parameter to come from specimen A while the remaining come from specimen B. Selection may be determined by the chosen metric. A random population of diamond proportion sets can be chosen as the initial population. A selection of those with the highest metric values are chosen to cross-over and mutate. The next generation is populated with copies of these offspring, and the process is iterated.

In an example embodiment, a method for generating all symmetric gemstone faceting arrangements up to a specified complexity can be provided. The method can include receiving a selection defining a symmetry type and a number of vertices for a crown and a pavilion. The method can also include storing a fundamental domain for each gem cut, positioning vertices as required and connecting each of the vertices with edges to create an abstract graph T. The method can also include enumerating all subgraphs of this graph, removing duplicates, and verifying connectivity of each subgraph. The method can also include, after expanding the graph to have a 3-fold symmetry, confirming a planarity and a tri-connectivity using a Tutte embedding and a facet tracing algorithm. The method can also include returning a list of all such graphs that satisfy one or more constraints and writing the list to a file.

In another example implementation, a tunable 3D model can be created by selecting a crown and pavilion using the methods described earlier. A complete search of parameter space or a search limited to ranges of certain parameters can be specified, as well as a metric to optimize. The computer can be instructed to implement a machine learning algorithm to find a best solution to be passed to a planning program for gem material cutting.

In some examples, a method for generating all possible geometric proportion sets for a faceting arrangement is provided. The method can include importing a faceting arrangement from a file or user input. The method can also allow for modifying the outer contour using Bezier curves or a similar modeling method. The method can also include assigning a spring tension to each edge. The method can also include creating a 3D model from this information, using the Maxwell-Cremona correspondence. The method can also include saving the 3D model to a file.

In some examples, the program generates and saves sets of 3D models based on user-defined ranges and step sizes.

In some examples, a method to allows for generation of all possible geometric proportion sets for a faceting arrangement is provided. The method can include importing the faceting arrangement from a file or user input. The method can also include adjusting the geometric model by using a program that converts desired geometric properties such as facet angle and azimuth, table size, and facet ratios into linear equations in the spring tensions. The program then solves the linear equations to produce a geometric model. The method can also include saving the 3D model to a file.

In some examples, the program generates and saves sets of 3D models based on user defined ranges and step sizes.

In an example implementation, a diamond design can be entered where the girdle thickness varies considerably. This model is converted to a tunable spring tension model, and the deviation of the girdle boundary from planarity is analyzed at each vertex. A gradient descent algorithm can be used to alter the spring tensions iteratively to create a model where the girdle thickness deviation has been reduced.

In one example implementation, the sets of 3D models that are generated are evaluated by a raytracing program to determine optical and other characteristics. The highest performing model can be selected and passed to a planning program for gem material cutting.

In another example implementation, the sets of the sets of 3D models that are generated are evaluated by a raytracing program to determine optical and other characteristics. A set of high performing models is collected into a library of models which are then passed to a planning program to allow more flexible fitting into a piece of gem material to be cut.

In some examples, a method to search the proportion sets of a particular diamond cut, or multiple cuts at once, via a genetic algorithm using defining parameters such as spring tensions as genetic material, in order to maximize a chosen metric.

In some examples, a neural network can be used to perform a regression model of the metric to improve computation times.

### BRIEF DESCRIPTIONS OF THE DRAWINGS

For a better understanding of the embodiments described in this application, reference should be made to the Detailed Description below, in conjunction with the following drawings in which like reference numerals refer to corresponding parts throughout the figures.

FIG. 1 is an image of the fundamental domains and generating graphs for standard round brilliant and princess crowns and pavilions in accordance with certain aspects described herein.

FIG. 2 is an image of a generating graph example in accordance with certain aspects described herein.

FIG. 3 is an image of all square graphs with 3 vertices in the fundamental domain in accordance with certain aspects described herein.

FIG. 4 is an image of all round brilliant type diamond crowns with up to 4 vertices in the fundamental domain in accordance with certain aspects described herein.

FIG. 5 is an image all round brilliant type diamond pavilions with up to 4 vertices in the fundamental domain in accordance with certain aspects described herein.

FIG. 6 is an image of the output of the process for simple crowns of the form (1,1,1,0) in accordance with certain aspects described herein.

FIG. 7 illustrates an example flow process of how the system as described herein can fit into the diamond manufacturing process and pipeline in accordance with certain aspects described herein.

FIG. 8 illustrates a second example flow chart of the diamond design process in accordance with certain aspects described herein.

FIG. 9 illustrates a set of example Five Fold Symmetry Designs in accordance with certain aspects described herein.

FIG. 10 is an illustration of an example networked system in accordance with certain aspects described herein.

FIG. 11 is an illustration of an example computer system in accordance with certain aspects described herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the particular embodiments. In other examples, well-known data structures, timing protocols, software operations, procedures, and components have not been described in detail so as not to unnecessarily obscure aspects of the embodiments herein.

### Overview

Gemstone cut planning, including rough, block, and recut planning, and equipment to perform the cuts are something the industry has struggled optimizing. A gemstone planner or cutter might take gem material and decide to cut it in order to create a gemstone that demonstrates specific light performance from the cut facets or is shaped a particular way from an optical design choice. But those gemstone cutters may also want to maximize the physical stone characteristics and size in order to get the largest and best polished stone as a result.

One of the many technical challenges for providing such planning, especially those that use cloud-based software solutions, is producing 3D wireframe models fitting the physical constraints of the gem material from which they will be polished. For example, databases exist for unique facet arrangements of submitted diamonds with many thousands of unique designs in terms of facet arrangement, but planners struggled with how to apply such theoretical designs to an actual scan of three dimensional gem material.

Additionally, for each possible facet arrangement, there exists any number of unique and independent parameters which may be used to define the geometry of the finished polished and cut gemstone or diamond. These parameters may include parameters like table size, crown angle, girdle thickness, various dimension ratios, and parameters that define the contour of the diamond. Trying to visualize all of those options and variables in a physical stone by eye is impossible.

It should be noted that use of the term gemstone or diamond is interchangeable and neither are intended to be limiting, and specifically includes the possibility of lab grown diamonds. The systems and methods here apply to any kind of stone or other material to be cut and faceted, the terms gemstone and diamond are merely non-limiting examples.

In other systems, the only decision a manufacturer had when cutting and polishing a diamond is the choice of which design to choose from the vast space of possible facet arrangements, and then the choices for parameters for the selected facet arrangement. In such examples, the manufacturer may well choose a design in attempt to yield the greatest size of the finished polished gemstone. However, it may be beneficial to also consider other factors such as but not limited to color, clarity and cut grades as these also impact a value of the finished polished gemstone.

Further, other available systems may be extremely expensive and labor intensive software engineering efforts and have limited visibility to the full space of design possibilities for a particular cut category (e.g. oval) as well as have limited parameter level resolution, and be such that 3D modeling efforts for each fancy facet arrangement are determined, one at a time. Furthermore, great care would need to be taken by these approaches to identify all the independent parameters, ensuring the parameter-space of a given model is fully solved for a given model. And there exist other subtle complexities, involving the validity of certain parameter choices, as most produce impossible solutions for polishing gemstones that cannot actually exist within the given physical parameters of the stone itself.

Systems and methods here may be used to solve these planning and modelling problems using one or more algorithms, from which every diamond or gemstone facet design may be produced, customized to the physical parameter-space for each design from either a physical rough stone or larger stone to be recut (including laboratory grown diamonds). In such a way, an input such as a wireframe, convex hull, or other volumetric model may be input into the system or into a third-party system, along with an input of what general or specific shape category is to be utilized. The systems and methods here may then output a solution that is then fine-tuned with various examples of candidate models with various yield and performance scores. Systems and methods may then be used to fine tune or narrow such a list of candidates into a top list of one, two, three or other desired number of best fits and performance scores.

This technical solution may allow planners to choose a design in a much more efficient and powerful way. It also this gives planners more options of shapes to choose from. It can also be useful for automated generation of pages of a diamond encyclopedia. Moreover, the algorithm(s) can be tailored to identify the physical parameters that most impact yield (Weight) and beauty (Cut, including contour appeal and virtual facet characteristics), creating systems that reduce the number of computations needed for design solutions.

The present embodiments as described herein explore the technology around planning and mapping many possible gem cuts and facet plans using the dimensions of the gem material and computer algorithms and software to model and map such plans. In some examples, a three dimensional model may be constructed for a hypothetical gemstone as well. In either case, the systems and methods may be used for design, whether the model represents an actual, physical stone which is scanned and a model is built to represent the scan, or whether the model is from a hypothetical stone. Thus, the systems and methods described herein may be used to present any number of potential plans to a user for selection, with the underlying information of the light performance, scintillation, sparkle, design, etc. of the gemstone if cut using the various options.

The method described herein for creating models for diamond planning and cutting can utilize the mathematics of spring tensions and the Maxwell-Cremona correspondence, which is a method to turn a set of spring tensions on the edges of a graph (plus a normal vector for a single facet) into a 3D model. This can solve the domain problem, when creating models with conventional parameters like angle, azimuth, star ratios, table sizes, and so forth, there can be many geometries that are impossible. However, any assignment of positive spring tensions corresponds to a legal geometry, which can allow for efficient searching through the space of possible geometries. The present embodiments can help those who specialize in planning gemstone cuts.

Many methodologies for studying different faceting arrangements involve use of programs to simulate cutting gemstones or virtually cutting stones. However, such methodologies generally did not include an ability to produce a list of many or even all possible gem cuts in order of increasing complexity. There also was not any system that gives the user complete control over all parameters of a gem shape. The present embodiments can use the method of spring tensions, combined with Bezier curve analysis of boundary contours, which can provide complete control over the gemstone's geometry and shape.

The systems and methods here utilize one or any number of algorithms and software implementation of such, for enumerating gem crowns and pavilions with various types of symmetries, including those with higher symmetry levels such as rounds and princess cuts, and those with lower symmetry levels such as oval, pear, and marquise shaped diamonds. They may be used for exploring the possible proportion sets for any given faceting arrangement. The particular method of enumeration here also can allow for searching this proportion space, also referred to as parameter space.

### Symmetry and Graphing Gemstone Examples

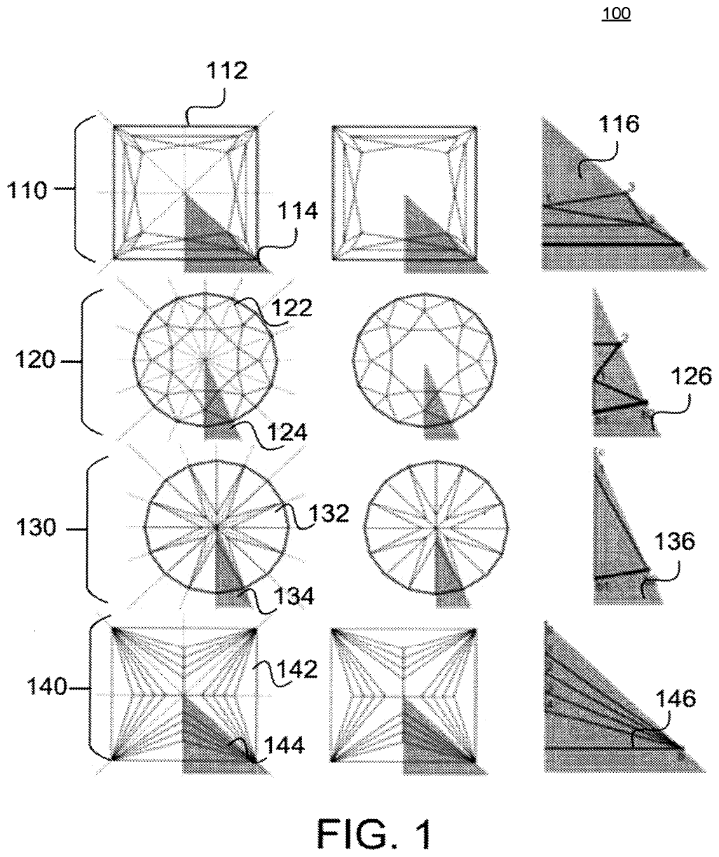

FIG. 1 shows an example illustration 100 of fundamental domains and generating graphs for standard round brilliant and princess crowns and pavilions of example gemstones. The images of the crowns and pavilions in the description here may be line drawings or wire drawings generated by a computer system of real, actual gemstones scanned and modeled. In some examples, this may be accomplished using a silhouette imaging system that can use the computerized images to build a three dimensional model. In some examples, the line drawing or wire drawings may be of theoretical gemstones that could be cut in gem material, for planning purposes. In any example, the representations of gemstone crowns and pavilions may be analyzed to determine which facets repeat around the lines of symmetry, and those facets plotted into a computer program that utilizes algorithm(s) to generate multiple plot examples.

Gemstone crowns and pavilions may be determined by their fundamental domains and symmetry order. So, to enumerate diamonds, it suffices to enumerate fundamental domains. Looking at diamonds in terms of their fundamental domains also allows grouping of similar faceting arrangements with different orders, thus, a standard round brilliant may have 3, 4, 5-fold symmetry and beyond.

The graphs output by the systems and methods described here can be turned into three-dimensional 3D wireframe or schematic models using the Maxwell-Cremona correspondence. This is a mathematical principle whereby an assignment of spring tensions to a planar network (graph) plus an assignment of a normal vector to a single facet is determinative of a particular 3D model geometry. In such a way, the systems and methods here can utilize these algorithms for generating computer created models with all of the requested parameters.

As shown in example FIG. 1, two common faceting arrangements are shown, round brilliant 120, 130 and princess cut 110, 140. The round brilliant (e.g., 120, 130) can include accompanying features (e.g., 122, 124, 126 and 132, 134, 136), and the princess cut (e.g., 110, 140) can include features (e.g., 112, 114, 116, and 142, 144, 146). It should be noted that these are examples only and the systems and methods described here may be applied to any number of gemstone shapes, cuts, sizes, or examples. The examples of princess cut and round brilliant are mere examples and are not intended to be limiting.

As shown in the example of FIG. 1, lines of symmetry can be overlaid on a mapping of gemstone facets and may be used to analyze gemstone faceting. In the example of FIG. 1 the lines of symmetry are used to divide each gemstone diagram into a set of congruent regions called fundamental domains. After determined, the congruent fundamental domains include a fraction of the overall crowns and pavilions which can be repeated in order to represent the entirety of the crown and pavilion diagram. This fraction of the crown or pavilion is called a generating graph. A single generating graph can be used to create a full crown or pavilion of any symmetry order.

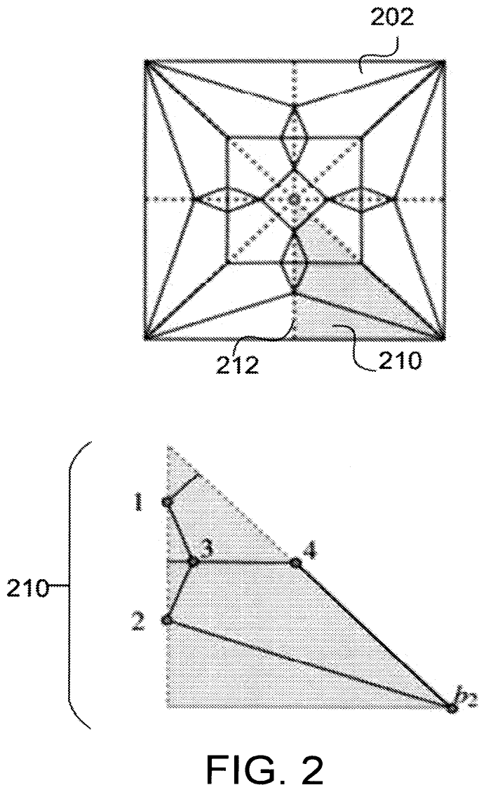

In use, a user may, for example, request a list of all stones of type (0,1,2,0) with 5-fold symmetry, where each of the quadruple (nL,nM,nR,nB) of nonnegative integers corresponds to the number of vertices that exist in certain places of the fundamental domain. For example, referring to feature 210 in FIG. 2, the first entry of the ordered quadruple (nL) counts the number of vertices on the left edge of the fundamental domain, the second entry (nM) counts the number of vertices in the interior of the fundamental domain, the third entry (nR) counts the number of vertices on the right wall of the fundamental domain, and the fourth entry (nR) counts the number of vertices on the bottom boundary. This information may be entered into a user interface program that then, from the request, generates all graphs of that type in a fundamental domain, and then uses five reflection lines to fill out the fundamental domain to the entire diamond shape.

In some examples, two separate tools may be used. The enumeration tool, may list all (0,1,2,0) graphs or more generally (nL,nM,nR,nB) graphs in a fundamental domain. The reader tool may prompt the user to input what order of symmetry he or she wants to use when creating the 3D model.

In some examples, a given diamond shape is input in the system, for example by wireframe mapping model and the system may determine lines of symmetry in the input model. Such a system may check all plausible lines of symmetry, for example, by connecting vertices and edge midpoints of the table in all possible ways. For each plausible line of symmetry, the system checks of all the vertices and edges are the same within tolerance if it the graph is reflected over that line. This can provide a method of classification for gemstone faceting arrangements.

One fundamental domain for each of the examples is shaded for example purposes 114, 124, 134, 144. Systems and methods here may take the fundamental domain examples and generate graphs labeling the vertices of the facets on the gemstones, 116, 126, 136, 146. In each of the fundamental domain examples, 116, 126, 136, 146 the vertices are labeled. In some examples, these labels and/or coordinates of the fundamental vertices may be stored in a computer database or computer storage.

A generating graph 116, 126, 136, 146 can have up to three corner boundary vertices. In the third row example 130, the three corner boundary vertices spots are labeled c, b1, b2 in FIG. 1, and if there is only one such vertex, it can be assumed it is in the lower right b2 position. In the first row example 110, the vertices are 1, 2, 3 and b, with b being a corner boundary vertex. In the second row example 120, the vertices are 2, 1, b2, b1, with b2 and b1 being corner boundary vertices. In the fourth row example 140, the vertices are c, 1, 2, 3, 4, b, with corner boundary vertices being c and b.

Turning now to the example in FIG. 2, which depicts an example generating graph of the gemstone pavilion and crown image 202 and the fundamental domain 210. The generating graph 210 shows the detail of the fractional portion from the full image 202. This can be a simple crown, with only a b vertex. There can be three types of vertices other than this corner boundary one. For example, the nL vertices lie along the left wall, the nM vertices lie in the triangle interior, and the nR vertices lie along the right wall, and the nB vertices lie along the bottom boundary. Thus, the two vertices labeled 1 and 2 lie on the left edge of the graph 210, corresponding to a line of symmetry in the original diagram that is adjacent to an edge 212. These can be called nL vertices. The vertex 3 is in the interior of the fundamental domain 210, which can be an nM vertex. Finally, vertex 4 lies on a line of symmetry adjacent to a corner, which can be an nR vertex. Vertices that lie along the bottom girdle can be nB vertices, though none are present in this particular diagram.

In FIG. 2, the graph is encoded by various data. The data can include the ordered quadruple (nL,nM,nR,nB) which can correspond to 1 and 2 as nL vertices, 3 which is an nM vertex and 4 which is an nR vertex. No nB vertices are present in this example. The data can also include edge connections of the vertices 1, . . . , 4: {1,3},{2,3},{3,4} 3. The edges that connect vertices with their reflections: {1,1},{3,3,−1}. Here the −1 indicates that the edge is reflected through the vertical line to the left of vertex. If the edge went through the diagonal boundary to its top and right, notation {3,3,+1} can be used. The list of vertices the corner attaches to, in this case, {2,4}.

Similarly, if there are other boundary vertices, vertices those connect to can be identified as well. For example, referring to FIG. 1, and suppressing reference to nB, features for various designs can be shown in Tables 1-4:

TABLE 1
Princess Crown

| | |
|---|---|
| (n_{L}, n_{M}, n_{R}) | (1, 1, 1) |
| (b₁, b₂, c) | (F, T, F) |
| edges | {{1, 3}, {1, 2}, {2, 3}, {2, 2, −1}} |
| b₂ connections | {2} |

TABLE 2
Princess Pavilion

| | |
|---|---|
| (n_{L}, n_{M}, n_{R}) | (4, 0, 1) |
| (b₁, b₂, c) | (F, T, T) |
| edges | {{1, 2}, {2, 3}, {3, 4}} |
| b₁ connections | {1, 2, 3, 4} |
| c connections | {1} |

TABLE 3
Round Brilliant Crown

| | |
|---|---|
| (n_{L}, n_{M}, n_{R}) | (1, 0, 1) |
| (b₁, b₂, c) | (T, T, F) |
| edges | {{1, 2}, {2, 2}} |
| b₁ connections | {1} |
| b₂ connections | {1} |

TABLE 4
Round Brilliant Pavilion

| | |
|---|---|
| (n_{L}, n_{M}, n_{R}) | (1, 0, 0) |
| (b₁, b₂, c) | (T, T, T) |
| edges | { } |
| b₁ connections | {1} |
| b₂ connections | {1} |
| c connections | {1} |

Given such combinatorial data, the embedded generating graph can be reconstructed as follows. First, choose some n and generate an abstract graph from the generating graph with symmetry group D2n (which corresponds to n lines of fold symmetry). A specified outer cycle can be used and one can apply the Tutte embedding. The Tutte Embedding is a way to take the description of the graph as a list of connections between vertices and turn it into a 2D picture in the plane. More specifically, the data above can be turned into an embedded 2D picture. Embedded means that the edges don't cross over each other. Finally, this can be restricted to a fundamental domain to get an embedded generating graph. I.e. to provide a method for taking an abstract list of nodes and connections with no geometric information and producing an actual two dimensional diagram of a diamond crown or pavilion and its generating graph.

### Pseudo Code Examples

In such an example, the algorithm may act like a sieve. First, all plausible graphs (abstract connections between vertices) are generated as described previously. The first step is to remove all duplicates so there is no accidental listing of the same graph twice.

The next step is to check if each graph is connected and discard the ones that are not. After that, each generating graph is reflected into a full graph using 3-fold symmetry (the smallest available) and that graph is checked for tri-connectivity. Any generating graphs that fail this step are discarded. Checking that the 3-fold reflected graph is tri-connected is sufficient to show that it will be tri-connected for any symmetry above 3. Tri-connectivity of a graph means that deleting any two vertices of the graph cannot disconnect the graph and is a sufficient condition for a graph to represent a three-dimensional polytope such as a diamond crown or pavilion. The graphs that have survived these checks can then be written to a file. They represent the list of graphs the algorithm was supposed to produce. In the case of enumerating graphs with symmetry n lower than 3, we check the n-fold reflected graph for tri-connectivity instead.

For example, more detailed pseudo code, fix the numbers nL,nM,nR, nB as well as the boundary vertex Boolean variables b1,b2, c that represent whether vertices are present in these three positions. In order to find all generating graphs with these data, list all possible feasible ways of abstractly connecting all of the relevant vertices, then checking them all for planarity, tri-connectivity and duplicates.

The number of possibilities can be pared down by considering some constraints. An example constraint can include the nL, nM and nB vertices each having to lie inside a subset of linear chains, which can be denoted Le and Li and Lb. Another example constraint can include the corner b2 vertex connecting to at most one c vertex, while a b1 vertex connects to at most one nL vertex. A center vertex can connect to at most one each of the nL and nR vertices.

These steps can be used to create a graph TGraph(a,b, c,d) on the nL,nM, nR, nB vertices with edges in the different classes. Example classes can include a linear chain on the ‘a’ vertices, all edges connecting ‘a’ vertices to ‘b’ and ‘c’ vertices, all edges connecting ‘b’ vertices to ‘b’ and ‘c’ vertices, linear chain on the ‘c’ vertices, a linear chain on the ‘d’ vertices, all self edges on the ‘a’ and ‘c’ vertices, and two types of self edges (k, k,1) and (k, k −1) on the ‘b’ vertices.

Next, graphs formed by all subsets of these edges can be considered, forming a list called abcdBoolSets. Each member of abcdBoolSets can be stored as an array of Boolean variables indicating whether a given edge is in or out.

The following can also be defined, for purposes of the algorithm. For instance, b1BoolSets encodes all possible sets of edges connecting b1 to the graph's interior vertices. Its members are arrays of a+b+c booleans, limited to at most one True in the first a slots. As another example, b2BoolSets encodes all possible sets of edges connecting b2 to the graph's interior vertices. Its members can be arrays of a+b+c booleans, limited to at most one True in the last c slots. As another example, centerBoolSets encodes all possible sets of edges connecting c to the graph's interior vertices. Its members can be arrays of a+b+c+d booleans, limited to at most one True in the first a slots and one True in the middle c. As another example, booleans cb1 and cb2 indicate whether there are edges connecting c to bi.

Next, the size of elements of abcBoolSets, b1BoolSets, b2BoolSets and centerBoolSets can be fixed to be j, k, 1, m respectively (iterating over all possibilities). For each element of these, a concatenated string of Booleans can be formed, which can give a list boolGraphSet.

The next stage in the process can be to remove duplicates caused by different labels of the same graph. The list of permutations Xabcd=Sa×Sb×Sc×Sd\{id}, i.e. the permutations that respect the vertex types can be considered. Each permutation σ can act on a boolean array in g∈boolGraphSet by computing the action on T(a,b, c,d) and the edges coming from b1,b2 and c. In some cases, an edge in g when acted on by σ may not lie in T(a,b, c,d), which means this is not a valid relabeling. If the relabeled graph is valid, this can call the result g·σ.

See Appendix Algorithm 2 for the pseudocode. Note that if a graph has a nontrivial automorphism, this algorithm will remove it. In this example, this is acceptable as any such graph will fail to be connected or tri-connected. In such a way, the feature of the algorithm that may look like a bug is actually not a problem. The useful graphs are supposed to be connected and tri-connected in order for them to correspond to 3D polytopes, and when removing duplicates, if a graph has a symmetry, this step will remove the original graph in addition to its duplicate.

After applying the duplicate removing algorithm, each generating graph can be checked for connectivity using depth first search.

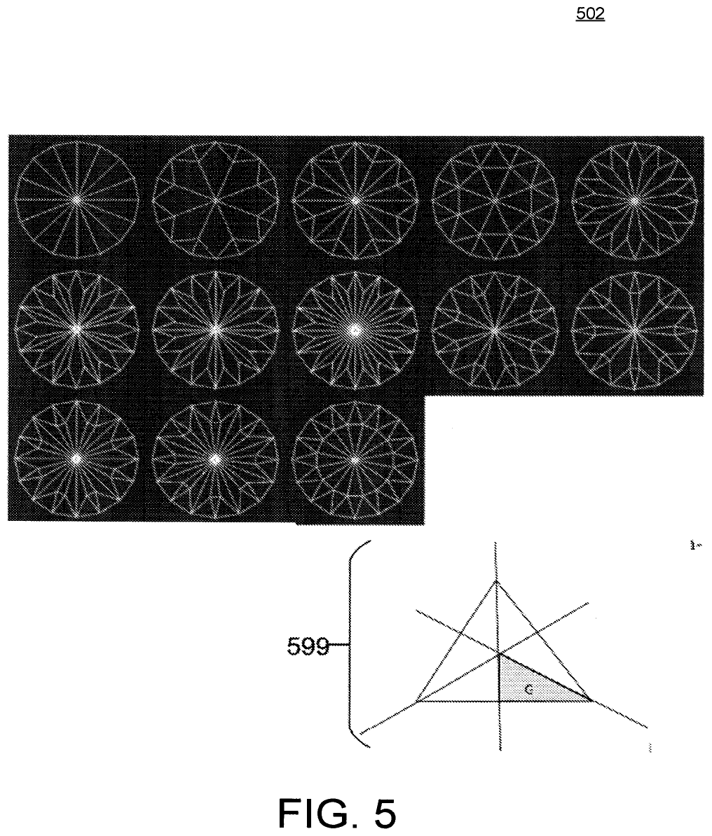

Next, each generating graph can be generated into a graph with 3-fold symmetry. This is an internal step to sift out the generating graphs that do not correspond to polytopes. The resulting generating graphs can and will be used later in the process to generate graphs of any symmetry order of 3 or above. For example, referring to FIG. 5, at 599, the generating graph G, put it inside a fundamental domain as shown, and then reflect it to fill out the entire figure. Then the program may check if this is embedded and tri-connected using Appendix algorithm 1 (recognizing trusses) as in the appendix. Tutte's spring-tension equilibrium map can then be applied and Appendix Algorithm 1 can be used to check if it is a truss. If not, it can be discarded. Again, in the case of enumerating graphs with n-fold symmetry lower than 3, the n-fold symmetric graph is generated instead.

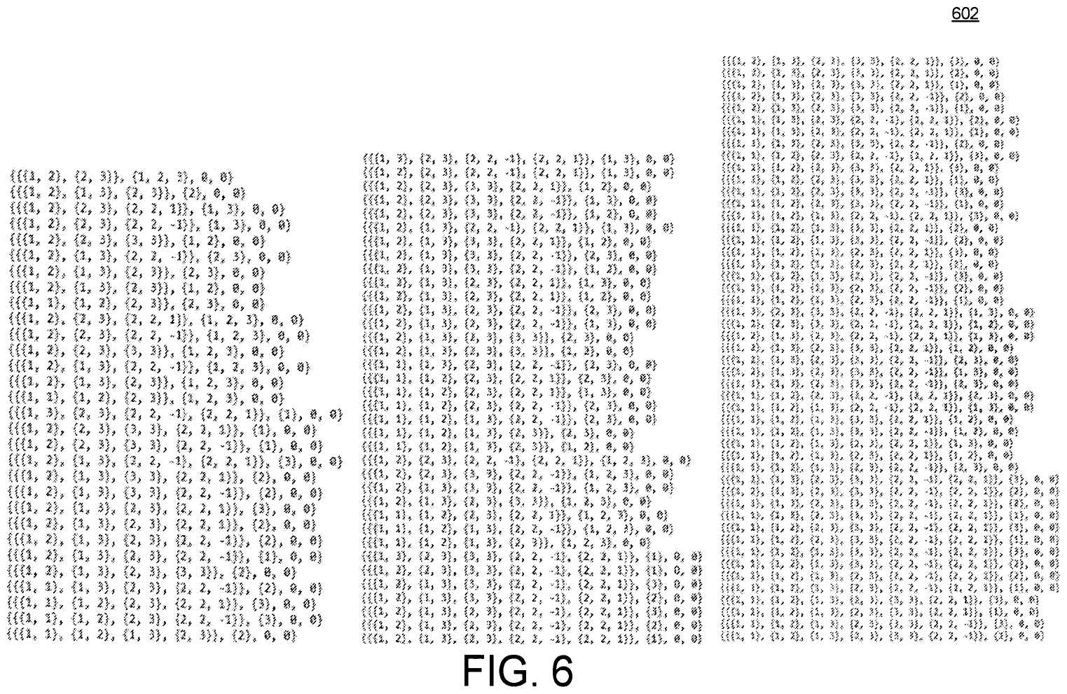

The remaining graphs are written to a computer file. See FIG. 6 as an example of results when (nL,nM,nR,NB)=(1,1,1,0) and the graph is simple. With these graphs, a computer software tool can generate a 3D wireframe model for analysis, including but not limited to using for gemstone cut planning on a piece of gem material.

### Graph Results Examples

The process described in the previous sections leads to a complete list of diamond crown and pavilion diagrams that satisfy a user's specified criteria.

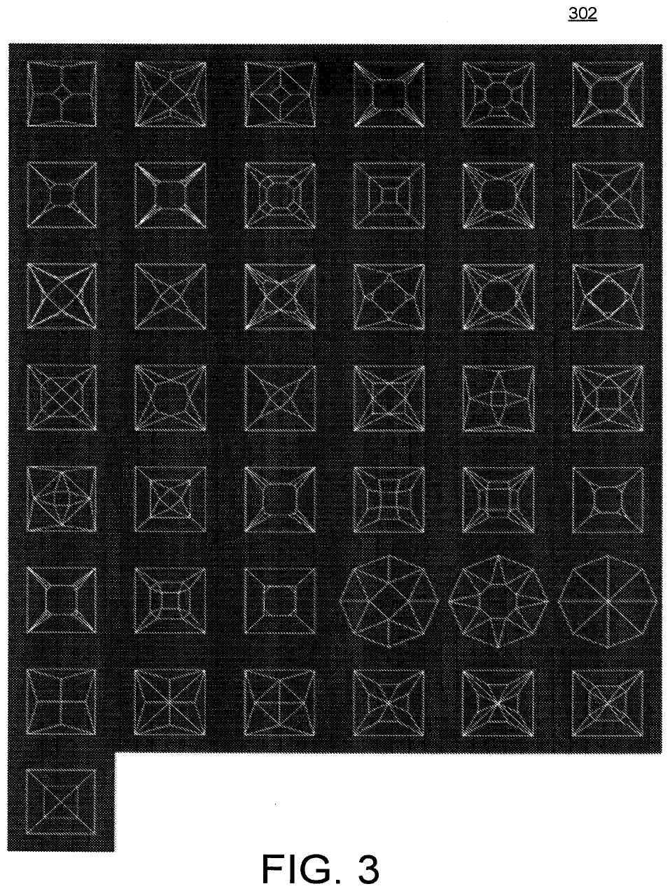

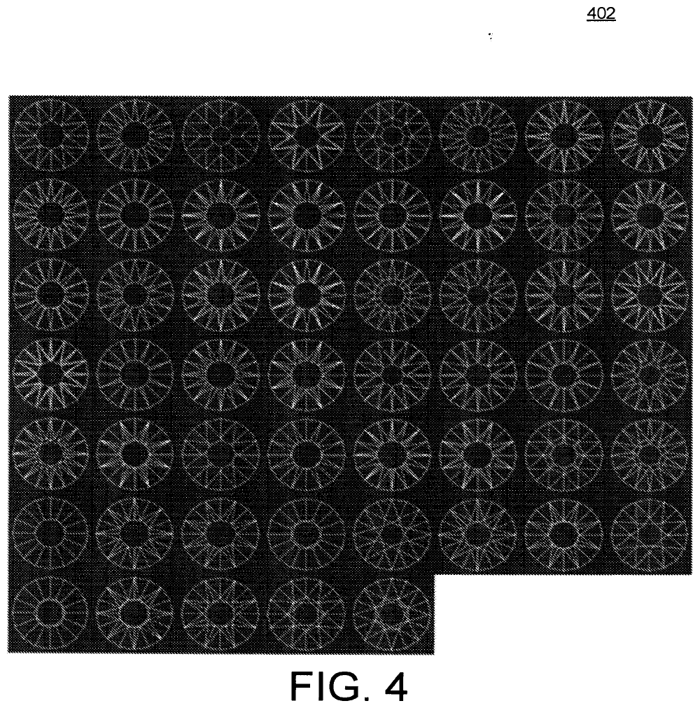

In Figures FIG. 3, FIG. 4 and FIG. 5, example results of the process are given for various constraints, showing all the combinations of pavilion and crown diagrams generated by the algorithms, systems and methods described herein.

In FIG. 3, examples of square graphs with three vertices in the fundamental domain are shown 302. In FIG. 3. all graphs 302 with symmetry group D8 and outer polygon a square such that the fundamental domain has 3 vertices or fewer are listed. In FIG. 4 the round brilliant type diamond crowns with up to 4 vertices in their fundamental domain.

FIG. 4 shows examples of all diamond crowns and pavilions with the same type of symmetry as a standard round brilliant and at most 4 vertices in the fundamental domain are shown 402.

FIG. 5 shows an example round brilliant type diamond pavilions with up to 4 vertices in the fundamental domain 502.

FIG. 6 shows an output 602 of the process for simple crowns in the form of (1, 1, 1,0).

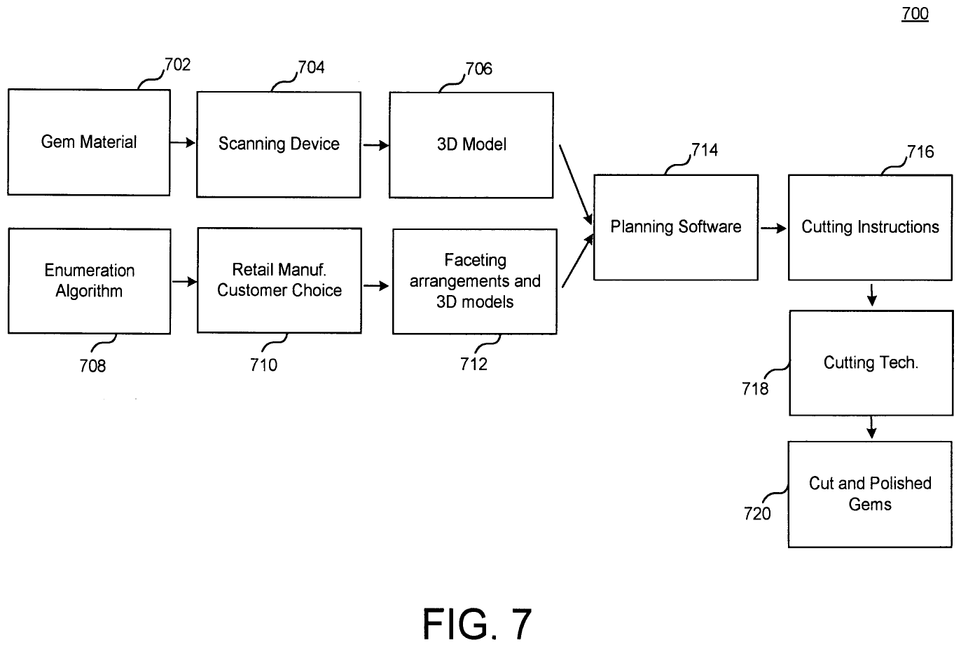

FIG. 7 illustrates an example flow process 700 of how the system as described herein can fit into the diamond manufacturing process and pipeline. For instance, in 702, a gem material can be provided. At 704, a scanning device can scan the gem material to generate a 3D model (e.g., at 706).

Further, at 708, an enumeration algorithm can be obtained. At 710, the enumeration algorithm can be applied based on a retail manufacturers customer choice. At 712, faceting arrangements and 3D models can be generated. At 714, planning software can obtain the 3D model (in 706) and/or the faceting arrangements and 3D models (in 712). At 714, cutting instructions can be obtained from the planning software, and at 718, cutting technology can be used to generate cut and polished gems (e.g., at 720).

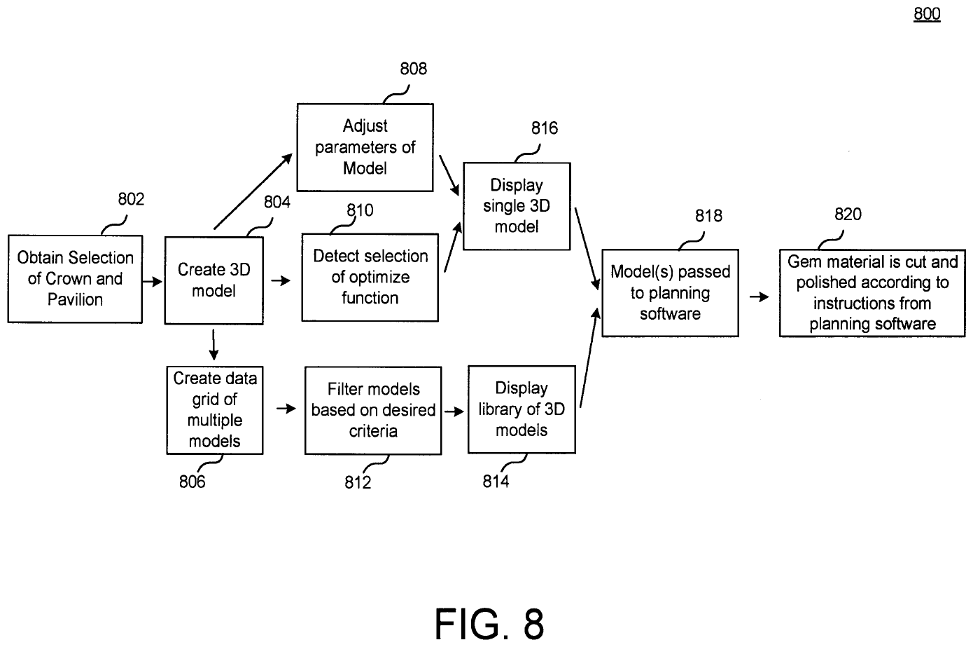

FIG. 8 illustrates a second example flow chart 800 of the diamond design process described herein. At 802, a selection of a crown and pavilion of a diamond can be obtained. At 804, a 3D model can be produced. At 806, a data grid for multiple 3D models can be created.

At 808, parameters of the 3D model can be adjusted. At 810, responsive to creating the model, a selection of an optimize function can be detected. At 816, a single 3D model can be displayed based on the adjusted parameters (in 808) and optimizing (in 810).

At 812, the data grid can be used to filter models based on desired criteria. At 814, the filtered models can be displayed as a library of 3D models. At 818, the models can be passed to planning software. At 820, the gem material can be cut and polished according to instructions provided by the planning software.

The graphs output by this process can be turned into 3D models using the Maxwell-Cremona correspondence. A set of positive spring tensions for the internal edges as well as a specified normal vector for a chosen facet can be used. This can provide the 3D model a set of tunable knobs which allows it to realize any possible convex stone geometry with the specified faceting arrangement.

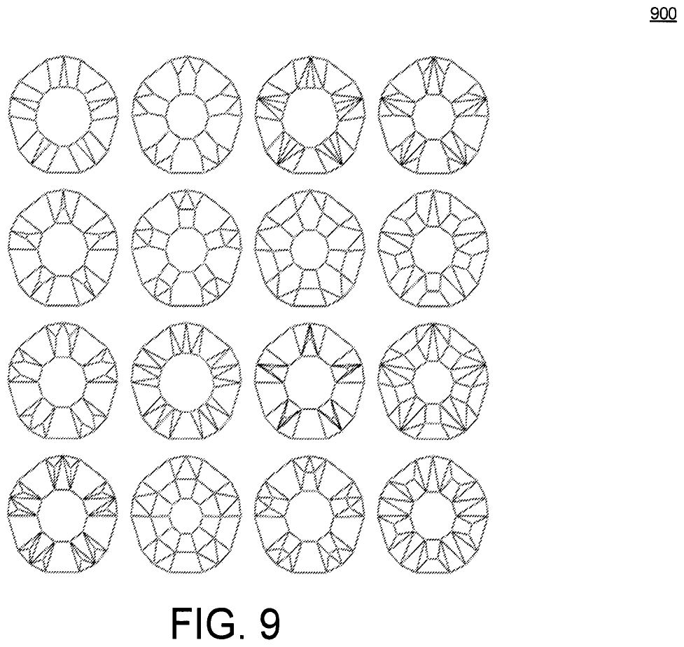

In some examples, the boundary may be modified using Bezier curves, giving an additional set of tunable knobs to control the diamond's outline. For example, in FIG. 9, the contours have been set to differ from a simple circular arrangement. Diamonds with only 2 lines of fold symmetry, may be set to have differing levels of boundary curvature and length-width ratios, giving ovals and marquise diamonds of various shapes. Diamonds with one line of symmetry can be converted to various styles of pear shape. One of the many advantages to modifying the boundary is to get different shape outlines with the same symmetry groups. Modeling them with Bezier curves allows a reduction of the boundary outline to a finite list of parameters controlling the boundary. This can give more or less broad-shouldered ovals, squarish versus roundish cushions, and so forth.

In the foregoing, a method for allowing a user to modify a 3D model to their desired parameters was given using the tunable knobs coming from spring tensions.

In some examples, a user can specify specific geometric parameters, rather than abstract spring tensions as input to an example program. For example, a user may want to adjust the following parameters of a diamond planned by the systems and methods here. Example parameters can include a facet's angle and azimuth, a vertex's z-coordinate, the diamond's diameter, the diamond's length/width ratio, the diamond's girdle depth, the diamond's table size, the diamond's culet position, the radial distance of vertices from the diamond's center, the diamond's outline as viewed from above.

Items 1 and 2 (facet angle and azimuth, and a vertex z coordinate) can be converted to linear equations in the spring tensions.

Items 3, 4 and 5 (a diameter, length/width ratio, and a girdle depth) can be affected through simple geometrical manipulation.

Items 6,7, 8 and 9 (a table size, a culet position, a radial distance of vertices, an outline) are handled by first performing a two dimensional transformation of the graph to change the given parameter, and then searching for 3D lifts satisfying any other given constraints.

In the case of item 9, one may also adjust the (x, y) coordinates of the interior vertices in addition to the vertices on the boundary. A gradient descent algorithm can be used to produce a girdle with as little height variation as possible.

Once the user specifies the constraints, the program searches for a positive spring tension solution which changes the diamond as little as possible, for example by using quadratic programming. The searching may utilize a quadratic programming algorithm. In some examples, constraints may be packaged into linear equations, then the linear system may be solved looking for solutions where all the spring tensions are positive, and which estimates a 3D model. A user interface may be used to receive the constraint parameters from a user input.

### Searching Parameter Space with AI and ML Examples

The systems and methods here can also include a method for searching the parameter space of a single cut or multiple cuts at once using artificial intelligence AI and Machine Learning (ML) methods. This searching can be useful to look for cuts that maximize certain features such as light return and scintillation. This can be applicable to the planning features, to be able to give cutting instructions to manufacturers on what proportion sets will maximize whatever metrics are chosen.

Stage 1 of an example method is to train a neural network as a regression model to predict diamond metric values based on parameter input. This can be done either for a specific cut, or for all cuts with a specific symmetry type and number of vertices. This stage may not be necessary but can be useful for reducing the amount of time it takes to calculate metrics.

Stage 2 can include applying a genetic algorithm to maximize any metric. This can be done for a single cut or for all cuts in a given symmetry class. It can also include other ML or AI techniques for optimization such as the COBYLA algorithm.

An algorithm can be a computational optimization technique inspired by the process of natural selection and evolution. It can use a population of candidate solutions, evolving them over multiple generations by applying operations analogous to genetic crossover, mutation, and selection. The objective can be to efficiently discover the best possible solution to a given problem by emulating the adaptive, iterative nature of biological evolution, in this example, applied to gemstone facet planning.

In some examples, the genetic material is the set of parameters describing a diamond proportion set. These could be traditional parameters like length/width ratio, and crown angle, or they could be the spring tension parameters, possibly augmented with girdle profile information. In the case that the cut itself may be variable, spring tensions can be used, with the convention that 0 spring tension means an edge is not present.

Genetic mutation can be accomplished by random variation of a subset of parameters. Crossover (mating) can be accomplished by choosing a subset of the parameter to come from specimen A while the remaining come from specimen B. Selection may be determined by the chosen metric.

A random population of diamond proportion sets can be chosen as the initial population. A selection of those with the highest metric values are chosen to cross-over and mutate. The next generation is populated with copies of these offspring, and the process is iterated.

Because the parameter space of fancy diamonds can be quite high dimensional, brute force approaches to looking for optimal proportions may not be feasible. However, a genetic algorithm can have the ability to seek out local maxima with far less computational effort.

In a first example embodiment, a method for generating all symmetric gemstone faceting arrangements up to a specified complexity can be provided. The method can include receiving a selection defining a symmetry type and a number of vertices for a crown and a pavilion. The method can also include storing a fundamental domain for each gem cut, positioning vertices as required and connecting each of the vertices with edges to create an abstract graph T. The method can also include enumerating all subgraphs of this graph, removing duplicates, and verifying connectivity of each subgraph. The method can also include, after expanding the graph to have a 3-fold symmetry, confirming a planarity and a tri-connectivity using a Tutte embedding and a facet tracing algorithm. The method can also include returning a list of all such graphs that satisfy one or more constraints and writing the list to a file.

In another example implementation, a tunable 3D model can be created by selecting a crown and pavilion using the methods described earlier. A complete search of parameter space or a search limited to ranges of certain parameters can be specified, as well as a metric to optimize. The computer can be instructed to implement a machine learning algorithm to find a best solution to be passed to a planning program for gem material cutting.

In some examples, a method for generating all possible geometric proportion sets for a faceting arrangement is provided. The method can include importing a faceting arrangement from a file or user input. The method can also allow for modifying the outer contour using Bezier curves or a similar modeling method. The method can also include assigning a spring tension to each edge. The method can also include creating a 3D model from this information, using the Maxwell-Cremona correspondence. The method can also include saving the 3D model to a file.

In some examples, the program generates and saves sets of 3D models based on user-defined ranges and step sizes.

In some examples, a method to allows for generation of all possible geometric proportion sets for a faceting arrangement is provided. The method can include importing the faceting arrangement from a file or user input. The method can also include adjusting the geometric model by using a program that converts desired geometric properties such as facet angle and azimuth, table size, and facet ratios into linear equations in the spring tensions. The program then solves the linear equations to produce a geometric model. The method can also include saving the 3D model to a file.

In some examples, the program generates and saves sets of 3D models based on user defined ranges and step sizes.

In an example implementation, a diamond design can be entered where the girdle thickness varies considerably. This model is converted to a tunable spring tension model, and the deviation of the girdle boundary from planarity is analyzed at each vertex. A gradient descent algorithm can be used to alter the spring tensions iteratively to create a model where the girdle thickness deviation has been reduced.

In one example implementation, the sets of 3D models that are generated are evaluated by a raytracing program to determine optical and other characteristics. The highest performing model can be selected and passed to a planning program for gem material cutting.

In another example implementation, the sets of the sets of 3D models that are generated are evaluated by a raytracing program to determine optical and other characteristics. A set of high performing models is collected into a library of models which are then passed to a planning program to allow more flexible fitting into a piece of gem material to be cut.

In some examples, a method to search the proportion sets of a particular diamond cut, or multiple cuts at once, via a genetic algorithm using defining parameters such as spring tensions as genetic material, in order to maximize a chosen metric.

In some examples, a method as in any of the previous examples can be used, which can use a neural network to do a regression model of the metric to improve computation times.

In another example implementation, the process as in the above implementation, wherein a consumer and/or retailer uses the above process to create a new diamond design and modify its proportions to their desired specifications.

A summary of the processes herein outlined is given in FIG. 7. The enumeration algorithm described herein is used to allow a user, such as a retailer, manufacturer, or customer, to choose a diamond design, which is then used to generate 3D models. These can be fed to planning software to plan the cutting of gem material which has been scanned with a measuring device.

A more detailed summary of examples of the processes herein outlined is given in FIG. 8. A user selects crown and pavilion from a list and a 3D model with tunable parameters is generated. From here, three example pathways are listed. A user can adjust the diamond model parameters by hand, or could push a button to generate an optimized model. These both lead to a single 3D model that can be passed to planning software for cutting. In another example implementation, the user creates a grid of multiple models which are screened to create a library that is then passed to planning software.

In another example implementation, using the collected list of diamond designs generated by the process described herein to create an interactive web-based diamond encyclopedia. A user would be able to select crown, pavilion, and rotation offset, and a page would populate with information about the diamond design, including an example 3D model, information about light performance and patterning, historical information about known cuts, and other potential fields.

The encyclopedia may also have the option of allowing the user to explore different proportion sets, have optimization tools available for a fee, or allow users to consult with a team of experts to create a beautiful design.

The architecture of the encyclopedia is made possible by the existence of a complete list of possible designs that can be generated using the techniques herein described.

FIG. 9 illustrates a set of example Five Fold Symmetry Designs 900. For instance, in FIG. 9, the designs 900 can depict (1,2,0,1) simple crowns with 5-fold symmetry. The designs 900 can include an ordered quadruple of (nL,nM,nR,nB).)

### Network Examples

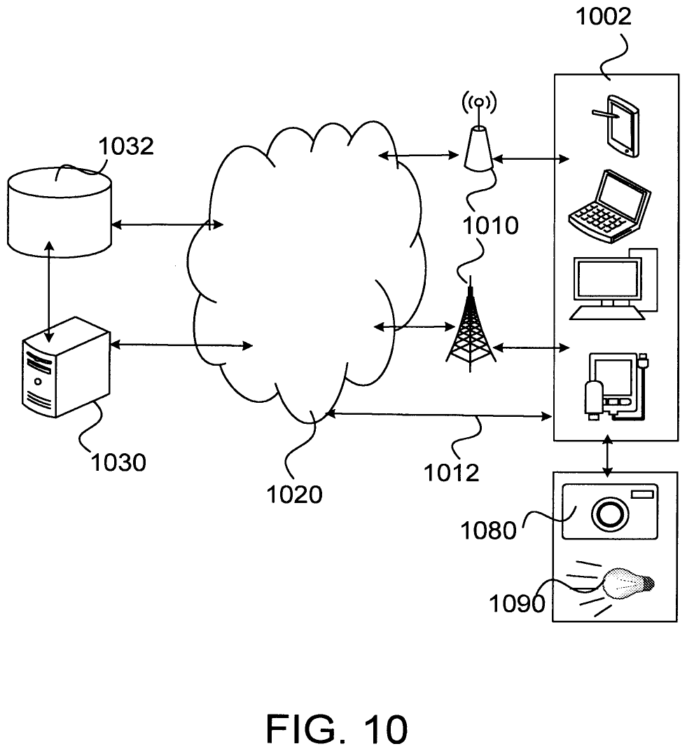

An example of a networked computing arrangement which may be utilized here is shown in FIG. 10. In FIG. 10, the computer 1002 used to process the vertex data. The computer 1002 could be any number of kinds of computers alone or in combination such as those included with the systems, including but not limited to a laptop, desktop, tablet, phablet, smartphone, or any other kind of device used to process and transmit digitized data. The computer 1002, additional or alternative examples are described in FIG. 8.

Turning back to FIG. 10, computer resources for any aspect of the system may reside in networked or distributed format over the network 1020. Further, the vertex data from whichever computer 1002 may be transmitted to a back end computer 1030 and associated data storage 1032 for saving and analysis. In some examples, the transmission may be wireless 1010 by a cellular or WiFi transmission with associated routers and hubs. In some examples, the transmission may be through a wired connection 1012. In some examples, the transmission may be through a network such as the internet 1020 to the back end server computer 1030 and associated data storage 1032. At the back end server computer 1030 and associated data storage 1032, the vertex data may be stored, analyzed, compared to previously stored data for planning, or any other kind of data analysis. In some examples, the data storing, analyzing, and/or processing may be shared between the local computer 1002 and a back end computing system 1030. Networked computer resources 1030 may allow for more data processing power to be utilized than may be otherwise available at the local computers 1002. In such a way, the processing and/or storage of image data may be offloaded to compute resources that are available on the network. In some examples, the networked computer resources 1030 may be virtual machines in a cloud infrastructure. In some examples, the networked computer resources 1030 may be spread across many multiple computer resources by a cloud infrastructure. The example of a single computer server 1030 is not intended to be limiting and is only one example of a compute resource that may be utilized by the systems and methods described herein.

### Example Computer Devices

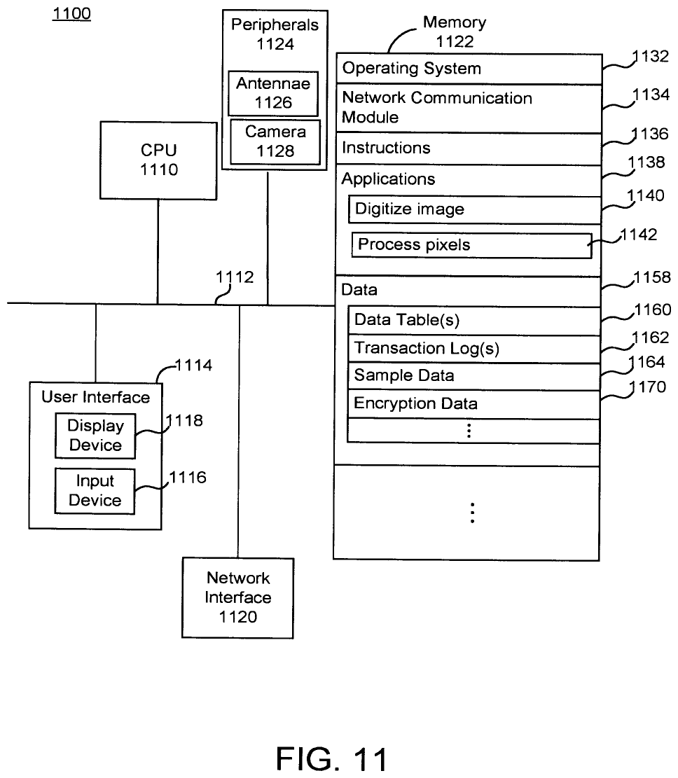

As described, any number of computing devices may be arranged into or connected with the various component parts of the systems described herein. For example, the camera systems may include their own computing systems, the lighting systems may include their own computing systems, the data from the camera images may be collected, stored and analyzed using computing systems. Such systems may be local and in direct connection with the systems described herein, and in FIG. 10. In some examples, some of the computing resources may be networked, or in communication over a network, such that they are not necessarily co-located with the optics systems described herein. In any case, any of the computing systems used here may include component parts such as those described in FIG. 11.

FIG. 11 shows an example computing device 1100 which may be used in the systems and performing the methods described herein. In the example computer 1100 a CPU or processor 1110 is in communication by a bus or other communication 1112 with a user interface 1114. The user interface includes an example input device such as a keyboard, mouse, touchscreen, button, joystick, or other user input device(s). The user interface 1114 also includes a display device 1118 such as a screen. The computing device 1100 shown in FIG. 11 also includes a network interface 1120 which is in communication with the CPU 1120 and other components. The network interface 1120 may allow the computing device 1100 to communicate with other computers, databases, networks, user devices, or any other computing capable devices. In some examples, the method of communication may be through WiFi, cellular, Bluetooth Low Energy, wired communication, or any other kind of communication. In some examples, the example computing device 1100 includes peripherals 1124 also in communication with the processor 1110. In some examples, peripherals include antennae 1126 used for communication. In some examples peripherals 1124 may include camera equipment 1128. In some examples, computing device 1100 a memory 1122 is in communication with the processor 1110. In some examples, this memory 1122 may include instructions to execute software such as an operating system 1132, network communications module 1134, other instructions 1136, applications 1138, applications to determine vertex data 1140, applications to process vertex data 1142, data storage 1158, data such as data tables 1160, transaction logs 1162, sample data 1164, encryption data 1170 or any other kind of data.

### CONCLUSION

As disclosed herein, features consistent with the present embodiments may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the embodiments or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the embodiments, or it may be more convenient to construct a specialized apparatus or system to perform the required methods and techniques.

Aspects of the method and system described herein, such as the logic, may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words comprise, comprising, and the like are to be construed in an inclusive sense as opposed to an exclusive or exhaustive sense; that is to say, in a sense of including, but not limited to. Words using the singular or plural number also include the plural or singular number respectively. Additionally, the words herein, hereunder, above, below, and words of similar import refer to this application as a whole and not to any particular portions of this application. When the word or is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the descriptions pertain that variations and modifications of the various implementations shown and described herein may be made without departing from the spirit and scope of the embodiments. Accordingly, it is intended that the embodiments be limited only to the extent required by the applicable rules of law.

The present embodiments can be embodied in the form of methods and apparatus for practicing those methods. The present embodiments can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the embodiments. The present embodiments can also be in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the embodiments. When implemented on a general-purpose processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

What is claimed is:

1. A method for creating a virtual gemstone model with a faceting arrangement, the method comprising:
obtaining, at a computer, a set of measurements relating to a gemstone;
detecting, at the computer, a selection of a crown and/or a pavilion of the set of measurements relating to the gemstone and one or more tunable gemstone parameters; and
generating, by the computer, a 3D model of the gemstone based on the selected crown and/or pavilion and the one or more tunable gemstone parameters, wherein the 3D model is configured to be used in planning or cutting a gemstone material;
obtaining, at the computer, an updated set of tunable gemstone parameters; and
modifying the 3D model based on the updated set of tunable gemstone parameters.

2. The method of claim 1, wherein generating the 3D model comprises combining the crown and pavilion and converting the crown and pavilion into the 3D model via a Maxwell-Cremona correspondence between the crown and pavilion.

3. The method of claim 1, further comprising:
obtaining a selection of one or more parameters of a set of tunable parameters to modify the 3D model and generate any possible gemstone geometry with a given facet arrangement of the gem material.

4. The method of claim 1, further comprising:
transmitting the 3D model to a planning tool configured to generate planning instructions for cutting and/or polishing the gem material.

5. The method of claim 1, further comprising:
obtaining, by the computer, a selection to optimize the 3D model with at least one metric selected; and
generating, by the computer, a maximized virtual 3D model that maximizes the selected metric.

6. The method of claim 5, further comprising:
creating, by the computer, an n dimensional grid of diamond geometries formed by varying chosen parameters;
filtering a set of models into a subset of virtual models based on the grid of diamond geometries formed by varying the chosen parameters;
selecting the subset of models as a library of models to be passed to the planning tool.

7. The method of claim 6, wherein multiple libraries of models are passed to the planning tool to allow multiple options in cutting and polishing the gem material.

8. The method of claim 1, further comprising:
implementing a trained neural network as a regression model to predict diamond metric values based on the one or more tunable gemstone parameters for either of a specific cut or all cuts with a specified symmetry type and number of vertices.

9. A system comprising:
a processor; and
a memory comprising instructions that, when executed by the processor, cause the processor to perform steps comprising:
obtaining a set of measurements relating to a gemstone;
detecting a selection of a crown and a pavilion of the set of measurements relating to the gemstone and one or more filters for a desired gemstone parameter; and
generating a 3D model of the gemstone based on the selected crown and/or pavilion and the one or more filters.

10. The system of claim 9, wherein generating the 3D model comprises combining the crown and pavilion and converting the crown and pavilion into the 3D model via a Maxwell-Cremona correspondence between the crown and pavilion.

11. The system of claim 9, wherein the steps further comprise:
obtaining a selection of one or more parameters of a set of tunable parameters to modify the 3D model and generate any possible gemstone geometry with a given facet arrangement of the gem material.

12. The system of claim 9, wherein the steps further comprise:
transmitting the 3D model to a planning tool configured to generate planning instructions for cutting and/or polishing the gem material.

13. The system of claim 9, wherein the steps further comprise:
obtaining a selection to optimize the 3D model with at least one metric selected; and
generating a maximized virtual 3D model that maximizes the selected metric.

14. The system of claim 13, wherein the steps further comprise:
creating an n dimensional grid of diamond geometries formed by varying chosen parameters;
filtering a set of models into a subset of virtual models based on the grid of diamond geometries formed by varying the chosen parameters; and
selecting the subset of models as a library of models to be passed to the planning tool.

15. The system of claim 14, wherein multiple libraries of models are passed to the planning tool to allow multiple options in cutting and polishing the gem material.

16. The system of claim 9, wherein the steps further comprise:
implementing a trained neural network as a regression model to predict diamond metric values based on the one or more tunable gemstone parameters for either of a specific cut or all cuts with a specified symmetry type and number of vertices.

17. A method for generating an optimized list of 3D models for a specified facet arrangement or facet arrangement type of a gemstone, the method comprising:
receiving, at a computer, a selection defining one or more target parameters which the list of 3D models fit inside;
receiving, at the computer, a list of facet arrangements;
receiving, at the computer, a list of performance and geometry criteria related to light performance, virtual facet patterning, outline, and/or weight, in the list of facet arrangements;
causing storage, by the computer, of the facet arrangements, virtual facet patterning, outline, and/or weight; and
generating a set of 3D models with different parameter sets, wherein the set of 3D models fit inside the target parameters and meets or exceeds the list of performance and geometry criteria.

18. The method of claim 17, wherein the target parameters are part of a wireframe of a rough gemstone or portion of rough gemstone from which a gem is configured to be polished.

19. The method of claim 17, wherein the generation of the set of 3D models are generated via a genetic algorithm using defining parameters including spring tensions as genetic material in order to maximize a volume yield of the gemstone.

20. The method of claim 17, wherein generating the set of 3D models includes combining a selected crown and pavilion and converting the crown and pavilion into the set of 3D models via a Maxwell-Cremona correspondence between the crown and pavilion.
